(19) United States
(12) Patent Application Publication
(10) Pub. No.: US 2017/0026470 A1
(43) Pub. Date: Jan. 26, 2017

(54) INTERCLOUD AUDIENCE AND CONTENT ANALYTICS

(71) Applicant: Cisco Technology, Inc., San Jose, CA (US)

(72) Inventors: Gaurav Bhargava, Chennai (IN); Srikanth Narasimhan, Bangalore (IN)

(21) Appl. No.: 14/806,493

(22) Filed: Jul. 22, 2015

(51) Int. Cl. H04L 29/08

(52) U.S. Cl. CPC H04L 67/1097; H04L 67/22; H04L 67/306

(57) ABSTRACT

Viewers of broadcast media are typically isolated from content creators, content distributors, and other interested parties. Gathering and using viewer data can prove expensive, slow, and complex. An example system that can be effective to overcome these limitations includes: a collection of data gathering devices configured to report data relevant to the content experience; a data provider public cloud configured to receive the data relevant to the content experience from the collection of data gathering devices, a processor for aggregating the data relevant to the content experience from the collection of data gathering devices and perform analytics thereon, and a third party service public cloud configured to maintain a secure tunnel between the third party public cloud and the data provider public cloud second communication interface.

### TECHNICAL FIELD

The present technology pertains to gathering data regarding participants in a content experience, and more specifically to using the data within an intercloud network.

### BACKGROUND

Broadcast media such as radio and television allow viewers and listeners to be isolated from content creators. While this enables millions of people to simultaneously experience the same production, it is typically a one-way transmission leaving content creators and distributors in the dark regarding how their content is received and how wide their distribution is. Industries typically rely on viewer and listener surveys, but these are slow, they only represent a small fraction of the total population, and they provide only basic information.

Once this information is collected, it can be difficult for interested parties to digest and incorporate this information into their business decisions. This difficulty impedes an entity in making timely and informed decisions based on the information.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example hybrid cloud architecture;

FIG. 1B illustrates an example of migrating a virtual machine in a hybrid cloud architecture;

FIG. 1C illustrates an example hybrid cloud wherein one private cloud is in communication with multiple public clouds;

FIG. 2 illustrates an example intercloud network connected to a data sensor in a position to monitor a content experience according to various embodiments;

FIG. 3 illustrates an example intercloud network with multiple service provider public clouds and multiple third party service public clouds; and

FIG. 4 illustrates example system embodiments.

### DETAILED DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for a better technique for gathering and using audience data and content data.

A “hybrid cloud” is a cloud infrastructure composed of two or more clouds that inter-operate or federate through technology. In essence, a hybrid cloud is an interaction between private and public clouds where a private cloud joins a public cloud and utilizes public cloud resources in a secure and scalable way. The hybrid cloud model provides the key advantages over other cloud models, such as by allowing enterprises to protect their existing investment, and maintain control of their sensitive data and applications, as well as their network, computing, and storage resources. In addition, hybrid clouds allow enterprises to readily scale their environment on demand. A significant advantage of a hybrid cloud is the capability to dynamically “migrate” resources between the private cloud and the public cloud; therefore it should be understood that the depiction of a resource on either cloud is not a limitation but an example placement unless explicitly described as a limitation.

A significant advantage of the “cloud” infrastructure is the ability to interoperate “virtual” resources with “bare-metal” resources. As such, many virtual resources can provide the same functionality as bare-metal resources and vice versa. Therefore, it should be understood that any depiction of a resource being a “virtual machine” or bare-metal is for purposes of illustration and not limitation.

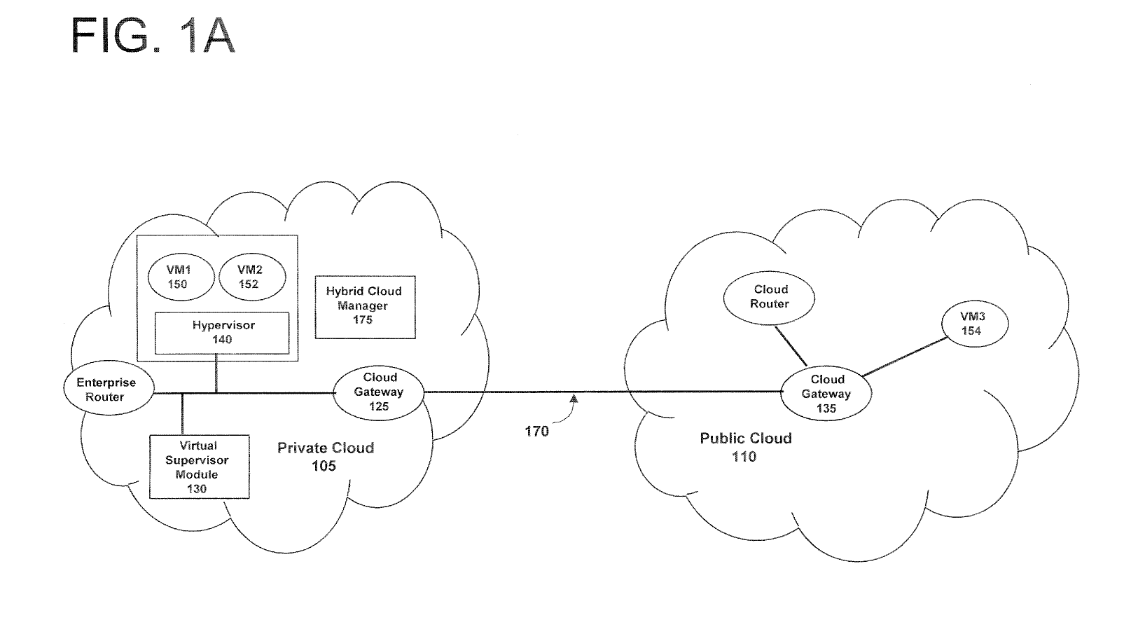

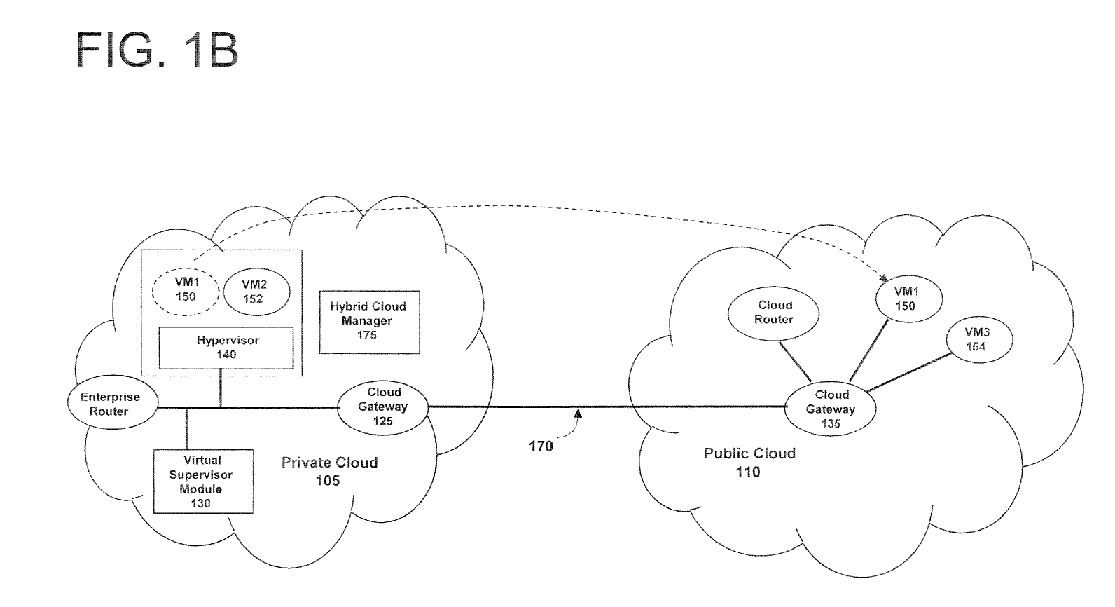

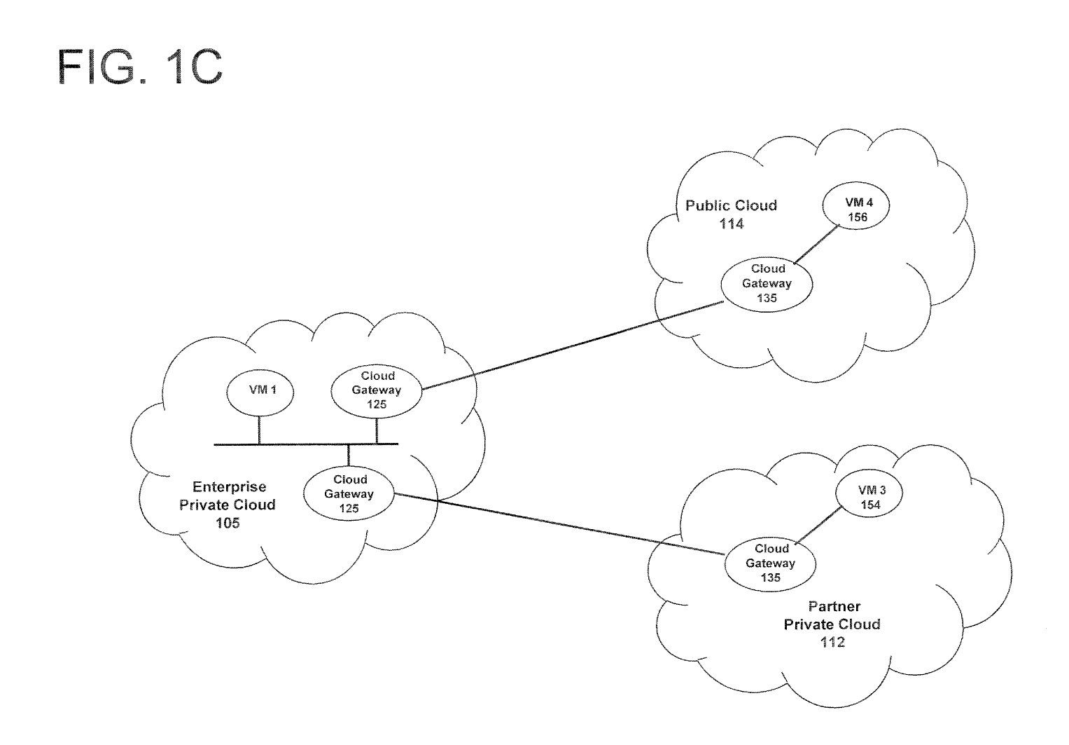

FIG. 1A illustrates an example hybrid cloud network illustratively comprising a plurality of networks or “clouds,” including a private cloud 105 (e.g., enterprise datacenters) and a public cloud 110 separated by a public network, such as the Internet (not shown). Although current terminology refers to a hybrid cloud comprising a private cloud and a public cloud, it should be understood that many aspects of this disclosure can be practiced in various multi-cloud configurations (e.g., two clouds hosted by third party providers or two enterprise clouds located in different locations). The private cloud 105 and public cloud 110 can be connected via a communication link 170 between cloud gateway 125 and cloud gateway 135. Data packets and traffic can be exchanged among the devices of the hybrid cloud network using predefined network communication protocols as will be understood by those skilled in the art.

As depicted in FIG. 1A, each cloud network element can have a cloud gateway 125 at the private cloud 105, a cloud gateway 135 at the public cloud 110, and at least one virtual machine (VM). For example, FIG. 1A illustrates VM1 150, VM2 152, at the private cloud 105, and VM3 154 (or nested VM containers) within the public cloud. The cloud gateway 125 at the private cloud can be configured as a VM running in the private cloud (enterprise datacenter) that is responsible to establish a communication link 170 for interconnecting the components in the public cloud with the private cloud. The cloud gateway 135 at the public cloud may be configured as a VM running in the public cloud that is responsible to establish the communication link 170 for connecting the cloud gateway 135 with cloud resources.

FIG. 1A also illustrates a hybrid cloud manager 175 within the private cloud 105 which can be a management plane VM for auto-provisioning resources within the hybrid cloud solution. Specifically, the hybrid cloud manager 175 is a management platform (which could be a VM) running in the private network, and may be generally responsible for providing the hybrid cloud operations, translating between private cloud and public cloud interfaces, management of cloud resources, dynamic instantiating of cloud gateways and cloud VMs components (VM3 154 in the public cloud 110) through the private virtualization platform and public cloud provider APIs. It may also health-monitor all the components (e.g., the cloud gateways, the one or more private application VMs, and the communication link 170 and provides high availability of those components.

FIG. 1A also illustrates a virtual supervisor module 130 (for example, the Nexus 1000V Switch by Cisco Systems, Inc.), a hypervisor 140 (also called a virtual machine manager) and one or more VM 150, 152. The virtual supervisor module 130 in the private cloud can be used to create VMs in the public or private cloud, such as VM1 150, VM2 152, and VM3 154. Each VM hosts a private application, even VM3 154 in the public cloud hosts a private application, and it is as though VM3 154 in the public cloud were within the private cloud. The hypervisor 140 can be configured by the virtual supervisor model 130, and provides an operating system for one or more VMs.

As introduced above, FIG. 1A also illustrates communication link 170. Communication link can take several forms include a type of VPN, or a tunnel. Specifically, some hybrid cloud technologies utilize an open virtual private network (VPN) overlay or else an IP security (IPSec) VPN based L3 network extension to provide communication link 170. While offering secure transport connections in a cloud environment, VPN does not provide a switch infrastructure for providing features such as switching network traffic locally at the cloud, providing consistent enterprise network polices, allowing insertion of various network services (e.g., load balancers, firewalls, etc.), and construction of a sophisticated network topology (e.g., the current systems are connected through a router and multiple VLANs). While IPsec-VPN-based technology can provide customers inter-datacenter network connectivity and relatively sophisticated network topologies, it can only extend the enterprise network at the network layer (Layer 3 or “L3” of the illustrative and well-known OSI model). This implies that the overlay networks created at the cloud datacenter (public cloud 110) must be a set of new subnets, where VMs in the public cloud are assigned with new network identities (e.g., IP and MAC addresses). Because of this, many of enterprise infrastructures (e.g., access control lists, firewall policies, domain name services, etc.) must be modified in order for the newly attached VM systems to be able to work with rest of the enterprise systems. Even the IPSec VPN tunnel would cause problems in penetration of corporate firewalls and Network Address Translation (NAT) devices deep within the enterprise datacenter (private cloud 105).

Some hybrid cloud technologies, such as the presently described technology, utilize a secure transport layer (e.g., Layer 4 or “L4”) tunnel as the communication link 170 between a first cloud gateway 125 in a private cloud 105 and a second cloud gateway 135 in a public cloud 110, where the secure transport layer tunnel is configured to provide a link layer (e.g., Layer 2 or “L2”) network extension between the private cloud and the public cloud. By establishing a secure transport layer (L4) tunnel 170 (e.g., transport layer security (TLS), datagram TLS (DTLS), secure socket layer (SSL), etc.) over the public network 115, the techniques herein build a secure L2 switch overlay that interconnects cloud resources (public cloud 110) with private clouds 105 (e.g., enterprise network backbones). In other words, the secure transport layer tunnel 170 provides a link layer network extension between the private cloud and the public cloud.

As noted, the cloud gateway 125 deployed at the private cloud 105 can use an L4 Secure Tunnel to connect to the cloud resources allocated at public cloud 110. The L4 secure tunnel is well-suited for use with corporate firewalls and NAT devices due to the nature of the transport level protocols (e.g., UDP/TCP) and the transport layer ports opened for HTTP/HTTPS in the firewall. The L2 network is thus further extended and connected to each of the cloud VMs, e.g., VM1 150, VM2 152, VM3 154 through the cloud gateway 135 deployed at the public cloud 110. With an L2 network overlay, all instances of a particular private application VM, e.g, VM3 154 can be seamlessly migrated to the overlay network dynamically created at the public cloud, without any impacts to the existing corporate infrastructure.

As a general practice, a public cloud service provider offers only a limited number of network attachments for each of the cloud VMs, e.g., VM3 154, and network broadcasting capability. This prohibits enterprise customers when migrating their multi-VLAN network architectural environment into the public cloud datacenter. However, building an L2 network overlay on top of L4 tunnels as described herein reduces the network attachments requirements for cloud VMs and provides cloud VMs with network broadcasting ability. The techniques herein thus allow enterprise customers to deploy consistent enterprise-wide network architectures, even in a hybrid cloud environment.

FIG. 1B illustrates a hybrid cloud environment as illustrated in FIG. 1A being used to migrate a VM from private cloud 105 to public cloud 110. Perhaps a VM on the private cloud needs to be scaled beyond the current resources of the private cloud, or perhaps the private cloud needs to be taken off line for a period of time. In either situation it can be desirable to migrate an application on the private cloud to the public cloud. FIG. 1B illustrates VM1 150 on private cloud 105 being migrated to public cloud 110, where it is illustrated as VM1 150₁. Migration is managed using virtual supervisor module 130 to take VM1 150 offline, and migrated using hybrid cloud manager 175 to copy the VM1 150 disk image to public cloud 110, and instantiate it in the public cloud.

FIG. 1C illustrates an example hybrid cloud environment. In FIG. 1C, a public cloud 114 is running an application or service in VM4 156. The application is shared by the enterprise private cloud 105 and partner private cloud 112. In such hybrid cloud environments a public cloud can act as an intermediary that provides limited access to the enterprise and the partner.

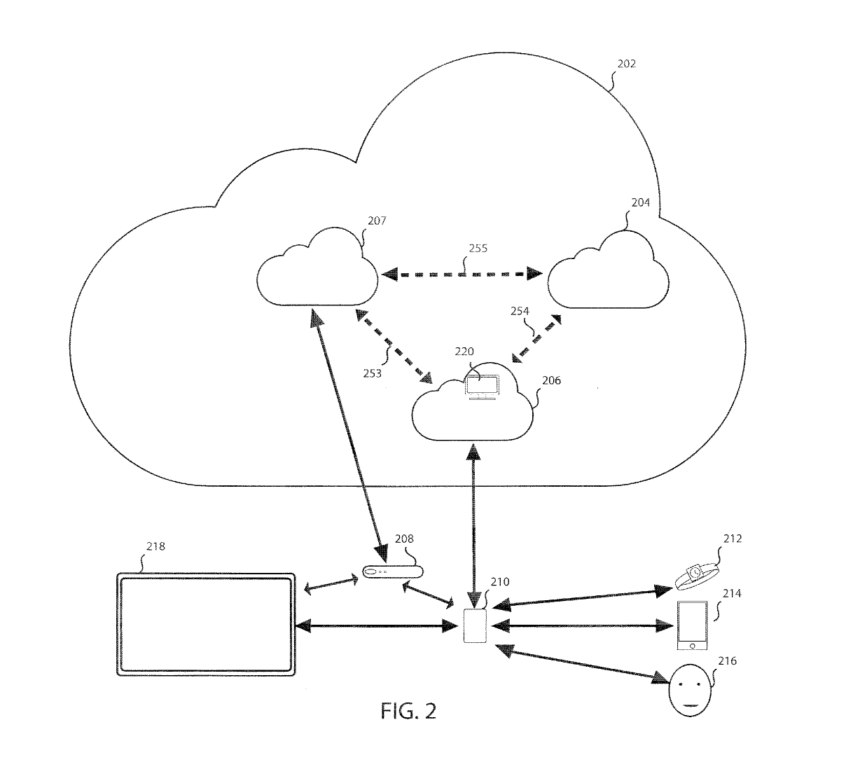

FIG. 2 shows an example intercloud network 202 according to various embodiments. Content device 208 can provide content to display 218. Content device 208 can be a set-top box, media streamer, RF tuner, videogame console, computer, or other type of device that prepares content for presentation on display 218. Display 218 can be a television, tablet, projector, computer monitor, etc. In some embodiments, content device 208 and display 218 are incorporated within a single unit such as a smart TV. In some embodiments, display has speakers for presenting audio.

It should be understood that the principles disclosed herein are equally applicable to other content experiences such as audio streams or videogames; such embodiments can use alternative devices to present content, e.g., using a speaker (for audio streams) instead of display 218. Similarly, the terms relating to viewing content can be interchanged with terms relating to listening (for an audio stream), playing (for a videogame), or terms related to any other content experience.

Data sensor 210 can gather content and audience data. Data sensor 210 can be a stand-alone device, be incorporated within content device 208, or be incorporated within display 218. In some embodiments, multiple data sensors 210 can separately gather different data in the same area. Data sensor 210 can detect content data based on what is presented on display 218. Content data can include channel information, program information, products and people currently presented on display 218, etc. For example, data sensor can detect the content's audio stream, compare the audio signature with a database, determine that a certain episode of a certain show is currently playing, and determine the current position in the show. In some embodiments, the audio stream has a watermark specifically designed for machine identification. Alternatively, in some embodiments, data sensor 210 is connected to, and receives content data directly from, content device 208 or display 218.

Audience data can be captured by identifying and profiling users that are within the vicinity of display 218. In some embodiments, data sensor 210 makes such a determination by identifying personal electronic devices that are associated with users like smart watch 212, phone 214, fitness tracker, smart card, handheld remote, etc. These personal electronic devices can be identified over Bluetooth, WiFi (802.11x), infrared, NFC, etc. Data sensor 210 can also detect audience data using facial recognition 216. Other biometrics can also be effective to identify users, such as their body dimensions, posture, and viewing habits (rapidly changing channels, channel preferences, etc.). Data sensor 210 can monitor and track the coming and going of multiple viewers during a viewing session. Data sensor 210 can monitor the current number of viewers, even if that number is zero. In some embodiments, a viewer manually enters in the relevant audience data. For example, a viewer can login to data sensor 210 or hit a button indicating they are currently viewing.

Audience data can include a user's heartrate, breathing, posture, room location, position relative to other users, blink rate, eye tracking, body heat signature, etc. This other information can help inform the current state of the user (tired, busy, attentive, distracted, etc.) and the relation between concurrent users (whether two users are romantically involved, if one user is a houseguest, that a parent-child relationship exists, etc.). Further, this information can be used to detect and determine how a user reacts to content (e.g., shock, agreement, amusement, indifference). Data sensor 210 can directly detect audience data or rely on data provided by personal electronic devices (smart watch 212, phone 214, etc.).

Data provider public cloud 206 can serve as a repository of audience data and content data gathered from multiple data sensors. The combination and analysis of audience data and content data can provide useful insights about individual user profiles (preferences, habits, demographics, etc.), channel data (overall viewership, regional reach, etc.), and program data. Some example insights include whether viewers typically watch a specific program alone or in a group, whether an individual viewer tends to change the channel during commercial breaks, whether viewers tend to mute certain commercials, whether viewers arrived at specific content directly or after “channel surfing”—perusing a variety of channels before arriving at the specific content, and if a certain viewer uses a “second screen” (laptop, phone, tablet, etc.) while viewing content on display 218. Audience data, content data, and insights (collectively “data of interest”) can be useful for various entities involved in content creation, content distribution, and viewer profiling.

Service provider public cloud 207 can be connected with, and publish content to, content device 208. In some embodiments, service provider public cloud 207 sources content from other providers; alternatively, service provider public cloud 207 can source (create) content internally.

Service provider public cloud 207, data provider public cloud 206, and third party service public cloud 204 can be a part of intercloud system 202. Public cloud denotes computing resources physically located in a location managed by an entity that is distinct from the entity that controls the resources; access to the general public is not required. Further, service provider public cloud 207, data provider public cloud 206, or third party service public cloud 204 can each be located on a private cloud, server network, etc. without diverging from the principles of this disclosure. Intercloud system 202 can be established through the federation of multiple public clouds (e.g., service provider public cloud 207, data provider public cloud 206, or third party service public cloud 204) interlinked using secure tunnels (e.g., secure tunnel 255, secure tunnel 254, and secure tunnel 253). Intercloud management service 220 can be a virtual machine located on any public cloud within intercloud network and can facilitate the creation of secure tunnels. Public clouds can have “interfaces” for their services by which other public clouds can send and receive data, typically through a secure tunnel. These interfaces can be a physical port, a virtual port, or any other mechanism or protocol that enables external communication. Further facilitating the creation of the secure tunnels, a public cloud can have a related virtual machine instance running on a different public cloud, which can be provisioned and configured by intercloud management service 220. A virtual machine instance can be directly accessible by its host cloud as well as its related public cloud. Intercloud management service 220 can organize and direct data flows between entities. However, not all public clouds need to be directly interlinked, for example, secure tunnel 253 might not be established and service provider public cloud 207 would thus not directly linked to data provider public cloud 206, though it can be indirectly linked through secure tunnel 255 and secure tunnel 254.

Intercloud system 202 enables data of interest to migrate between data provider public cloud 206, provider public cloud 206, and third party service public cloud 204. In some embodiments, data of interest is housed on a virtual machine located on data provider public cloud 206. Third party service public cloud 204 and service provider public cloud 207 can utilize the data of interest for various purposes. For example, data of interest can inform decisions regarding content distribution, facilitate viewer engagement, facilitate viewership payment schemes, as well as uses external to content delivery. Other example third party service public clouds 204 can be associated with retail services, online retail services, big data and interactive services, biometric data services, research institutions, on demand streaming services, television audience measurement services, billing and provisioning services, advertisement creators, advertisement distributors, content creators, content distributors, broadcast networks, social networks, online storage solutions, etc.

In some embodiments, third party service public cloud 204 is associated with the creation of content items. Such third party service public cloud 204 can utilize the data of interest to determine the effectiveness of a content item such as an advertisement (for example, determining that viewers generally muted the media item, changed the channel, reacted positively, etc.) or inform how to improve content item creation in the future (help determine what makes an effective or enjoyable content item, etc.).

In some embodiments, third party service public cloud 204 is associated with the distribution of media items. Such third party service public cloud 204 can utilize the data of interest to inform dynamic distribution decisions. For example, third party service public cloud 204 can use information of interest to bid for placements of a media item such as an advertisement (on the current content or future content) or determine payments to content producers (e.g., a contract may be dependent on viewership and audience reactions). In some embodiments, third party service public cloud 204 can learn of a product currently on display 218 and present an advertisement for the viewer, through either content device 208 or other means (such as a viewer's phone). For example, a viewer may be watching a show where a character is wearing a new brand of sneakers, data sensor 210 can determine that the sneakers are being featured and that the viewer is in the room, third party service public cloud 204 can determine that the viewer may be particularly interested in the sneakers, and third party service public cloud 204 can send an advertisement for the sneakers to the viewer's phone or have the advertisement overlaid on the content showing on the display. In some embodiments, different media items such as advertisements are provided to different viewers even though they are viewing the same content. In some embodiments, the media items incorporate elements specific to a viewer, such their social media profile, a relevant picture they posted on social media, or an advertisement personalized to the viewer.

In some embodiments, third party service public cloud 204 can be associated with a contextual content entity. Such entities could utilize secure tunnel 254 to incorporate data of interest into a report that can be sent over secure tunnel 255 to service provider public cloud 207 which can dynamically create content for viewers. For example, the content creation entity could have viewer-voting segments where viewers could influence the outcome of the content based on their votes. In another example embodiment, viewers could “cheer” for their favorite contestant in a game show, data sensor 210 can record the intensity of the cheer which ends up contributing to the data of interest; content creation entity can receive an indication of the average intensity of cheers for various contestants and overlay the results on the content as it is sent to display 218. Using these techniques can enable content creation entities and contextual entities to dynamically engage viewers.

Thus configured, a content feedback loop can help service provider public cloud 207 to modify content according to viewer reactions. For example: service provider public cloud 207 can disseminate content to content device 208 which can present the content on display 218; data sensor 210 can identify the content from the display as well as viewer information (demographics, reactions, etc.) and send this data to data provider public cloud 206; data provider public cloud 206 can perform analytics on the data and produce data of interest for service provider public cloud 207; and service provider public cloud 207 can use the data of interest to dynamically modify their content. For example, a news anchor can detect that their viewers are particularly excited when the news anchor mentions a certain aspect of a story, thus informing the news anchor to return to that aspect. Another example includes viewers cheering for their favorite contestant in a game show and the contestant with the most cheers wins.

In some embodiments, third party service public cloud 204 is associated with an entity that uses the data of interest for profiling viewers. For example, third party service public cloud 204 can be associated with a textile company; the textile company can use the data of interest to track the habits and interests of their target demographic and determine current trends and fads that should be incorporated into their product line. In some embodiments, third party service public cloud 204 is associated with big data services and can use data of interest to aggregate viewer behavior with various online services in order to create a more complete profile of the viewer and provide better contextual experiences across various online services.

In some embodiments, service provider public cloud 207 exposes a contextual user experience opportunity to third party service public cloud 204. This facilitates third party service public cloud 204 in providing content enhancements to service provider public cloud 207. Content enhancements include a contextual information overlay (i.e., a display element related to contextual information to be overlaid on content), advertisements for presentation, etc. In some embodiments, third party service public cloud 204 utilizes data of interest to create contextual information overlays to be placed upon the content. For example, the current content can be a sporting event and the data of interest can include the percentage of viewers that wear their team's colors; third party service public cloud 204 can then create a bar graph representing this data of interest and can send the bar graph to service provider public cloud 207 which can overlay the bar graph on the video stream of the event to represent which team has the more dedicated fans.

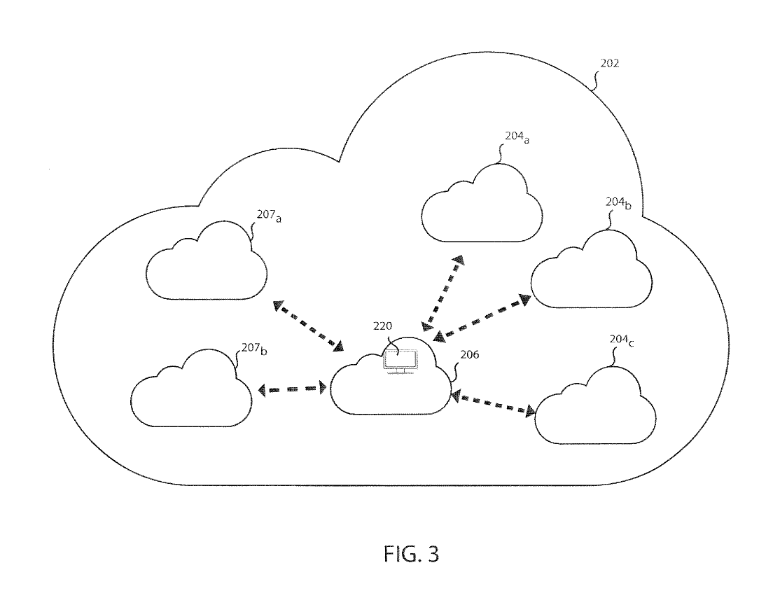

FIG. 3 illustrates how intercloud network 202 can contain multiple service provider public clouds and multiple third party service public clouds. For example, service provider public cloud 207a and service provider public cloud 207b can be associated with different types of media such as radio and television, different channels, different distribution networks, etc. In some embodiments, distinct service provider public clouds 207 are connected to distinct content devices 208; alternatively, they could publish content to the same content device 208. Multiple third party service public clouds can also connect to data provider public cloud 206. For example, third party service public cloud 204a, third party service public cloud 204b, and third party service public cloud 204c can all be associated with different services and entities. Intercloud management service 220 can organize the secure tunnels between these public clouds and direct traffic between entities.

Example Devices

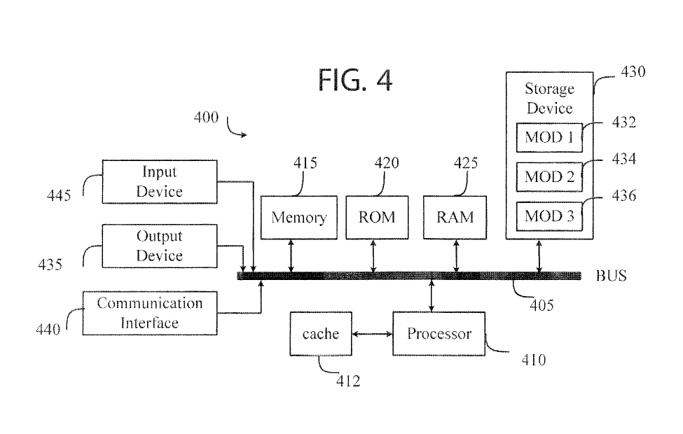

FIG. 4 illustrates an example system embodiment. Persons of ordinary skill in the art will also readily appreciate that other system embodiments are possible.

FIG. 4 illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 470 and random access memory (RAM) 475, to the processor 410. The system 400 can include a cache of high-speed memory connected directly with, in close proximity to, or integrated as part of the processor 410. The system 400 can copy data from the memory 415 and/or the storage device 430 to the cache 417 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 437, module 7 434, and module 3 436 stored in storage device 430, configured to control the processor 910 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 475, read only memory (ROM) 470, and hybrids thereof.

The storage device 430 can include software modules 437, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

It can be appreciated that example system 400 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

1. A system of public clouds participating in intercloud management service comprising:
a collection of data gathering devices configured to report data relevant to a content experience
a data provider public cloud including a first communication interface configured to receive the data relevant to the content experience from the collection of data gathering devices, a processor for aggregating the data relevant to the content experience from the collection of data gathering devices and perform analytics thereon, and a second communication interface; and
a third party service public cloud including a third communication interface configured to maintain a secure tunnel between the third party public cloud and the data provider public cloud second communication interface, the secure tunnel established by the intercloud management service,
wherein the intercloud management service is configured to migrate at least a portion of the aggregated data relevant to the content experience and analysis thereof from the data provider public cloud to the third party service public cloud.

2. The system of claim 1, further comprising:
a service provider public cloud configured to expose a contextual user experience opportunity to the third party service, wherein the service provider public cloud transmits content to the data gathering devices for consumption by users, the content for the contextual user experience can be received from the third party service public cloud.

3. The system of claim 2, wherein the intercloud management service is configured to establish a secure tunnel between the service provider public cloud and the third party service public cloud, and is configured to establish a virtual machine of the third party service on the service provider public cloud.

4. The system of claim 3, wherein the virtual machine of the third party service on the service provider public cloud is configured to access the contextual user experience opportunity from the service provider public cloud.

5. The system of claim 1, wherein the third party service public cloud is configured to determine whether to request to distribute content to a service provider public cloud based on the at least a portion of the aggregated data relevant to the content experience and analysis thereof.

6. The system of claim 1, wherein the third party service public cloud is configured to determine whether a content item distribute to a service provider public cloud based on the at least a portion of the aggregated data relevant to the content experience and analysis thereof.

7. The system of claim 1, wherein the at least a portion of the aggregated data relevant to the content experience and analysis thereof is used to determine a real time audience demographic profile for content distributed by a service provider.

8. A method comprising:
establishing a secure tunnel with a data provider public cloud using an intercloud management service; and
receiving audience and content data from the data provider public cloud.

9. The method of claim 8, establishing a secure tunnel with a service provider public cloud using an intercloud management service, receiving, over the secure tunnel with the service provider public cloud, data regarding a contextual user experience opportunity from the service provider public cloud.

10. The method of claim 9, comprising:
establishing a virtual machine on the service provider public cloud using the intercloud management service.

11. The method of claim 10, wherein the virtual machine of the third party service on the service provider public cloud is configured to access the contextual user experience opportunity from the service provider public cloud.

12. The method of claim 8 comprising:
determining to request to distribute content to a service provider public cloud based on the audience and content data.

13. The method of claim 8, comprising:
determining a content item to distribute to a service provider public cloud based on the on the audience and content data.

14. The method of claim 8, wherein the audience and content data is used to determine a real time audience demographic profile for content distributed by a service provider.

15. A non-transitory computer-readable medium having computer readable instructions stored on the computer readable medium that, when executed are effective to cause a computer to:
establish a secure tunnel with a data provider public cloud using an intercloud management service; and
receive audience and content data from the data provider public cloud.

16. The non-transitory computer-readable medium of claim 15, wherein the instructions are further effective to cause the computer to:
establish a secure tunnel with a service provider public cloud using an intercloud management service; and
receive, over the secure tunnel with the service provider public cloud, data regarding a contextual user experience opportunity from the service provider public cloud.

17. The non-transitory computer-readable medium of claim 16, wherein the instructions are further effective to cause the computer to establish a virtual machine on the service provider public cloud using the intercloud management service.

18. The non-transitory computer-readable medium of claim 17, wherein the virtual machine of the third party service on the service provider public cloud is configured to access the contextual user experience opportunity from the service provider public cloud.

19. The non-transitory computer-readable medium of claim 15 wherein the instructions are further effective to cause the computer to determine to request to distribute content to a service provider public cloud based on the audience and content data.

20. The non-transitory computer-readable medium of claim 15 wherein the instructions are further effective to cause the computer to determine a content item to distribute to a service provider public cloud based on the on the audience and content data.
